(19) United States
(12) Patent Application Publication
(10) Pub. No.: US 2006/0016298 A1
(43) Pub. Date: Jan. 26, 2006

(54) Hand tool for detaching rim from a vehicle

(76) Inventor: Hsueh Chin Chang, Taichung City (TW)

Correspondence Address: Hsueh Chin Chang, P.O. Box 63-150, Taichung City, TW

(21) Appl. No.: 10/939,267

(22) Filed: Sep. 13, 2004

(30) Foreign Application Priority Data
Jul. 20, 2004 (TW) 093211484

(51) Int. Cl. B25B 23/16

(52) U.S. Cl. 81/177.5; 81/177.2; 81/124.7

(57) ABSTRACT

A hand tool for detaching rim from a vehicle includes a main shaft having a seat formed on a middle portion thereof and dividing the main shaft into a first section and a second section. A socket detachably mounted to a free end of the first section for driving bolts. A grip is rotatably sleeved on the second section of the main shaft for user to control the main shaft. A drive shaft pivotally and movably extends through the seat. The drive shaft has a taperingly flatted first end such the drive shaft can be used as a lever for detaching a rim cover. The drive shaft has a second end used as a stopper to prevent the drive shaft from overly extending through the seat and detaching from the main shaft during operating.

### BACKGROUND OF THE INVENTION

1. Field of the Invention

The present invention relates to a hand tool, and more particularly to a hand tool for detaching rim from a vehicle.

2. Description of Related Art

A conventional hand tool for detaching rim from a vehicle in accordance with the prior art shown in FIG. 7 comprises an L-shaped rod. The L-shaped rod has a first section and a second section (2) having a length longer than that of the first section such that the second section (2) is used as a lever arm (S). The first section has a free end formed with a socket (1) and the second section has a tapered free end (3). Before detaching the rim, the second section of the L-shaped rod is used as a lever to remove a rim cover (not shown) from the rim. The socket (1) is sleeved on the head of the bolt (5) to release the bolt (5). The length of the second section (2) of the L-shaped rod can not be adjusted and there is no ratchet device in between the socket (1) and the first section of the L-shaped rod. Consequently, the tapered free end of the second section of the L-shaped rod may abut against the ground and the user needs to repeat the steps of detaching the hand tool from the bolt, sleeving the socket (1) on the bolt (5) and rotating the bolt again till the bolt (5) is detached from the wheel axle of the vehicle. However, the rim usually needs at least four blots for fixing. As a result, the user will spend a lot of time to detach the rim form the vehicle. In addition, the conventional hand tool for detaching the rim is inconvenient for being carried and transported. Consequently, the manufacturer may spend a lot of money for transporting the tools.

The present invention has arisen to mitigate and/or obviate the disadvantages of the conventional hand tool for detaching rim from a vehicle.

### SUMMARY OF THE INVENTION

The main objective of the present invention is to provide an improved hand tool that can effectively and quickly detaching the rim from a vehicle.

To achieve the objective, the hand tool in accordance with the present invention comprises a main shaft having a seat formed on a middle portion thereof and dividing the main shaft into a first section and a second section. A socket detachably mounted to a free end of the first section for driving bolts. A grip is rotatably sleeved on the second section of the main shaft for user to control the main shaft. A drive shaft pivotally and movably extends through the seat. The drive shaft has a taperingly flatted first end such the drive shaft can be used as a lever for detaching a rim cover. The drive shaft has a second end used as a stopper to prevent the drive shaft from overly extending through the seat and detaching from the main shaft during operating.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a hand tool for detaching rim from a vehicle in accordance with the present invention;

FIG. 2 is a perspective view of the hand tool for detaching rim from a vehicle in accordance with the present invention;

FIG. 3 is a partially cross-sectional view of the handle tool in FIG. 2 along line 3-3;

FIG. 4 is another perspective view of the hand tool in accordance with the present invention;

FIG. 5 is a first perspective operational view of the hand tool of the present invention;

FIG. 6 is a second perspective operational view of the hand tool of the present invention; and

FIG. 7 is a perspective view of a conventional hand tool for detaching rim from a vehicle in accordance with the prior art.

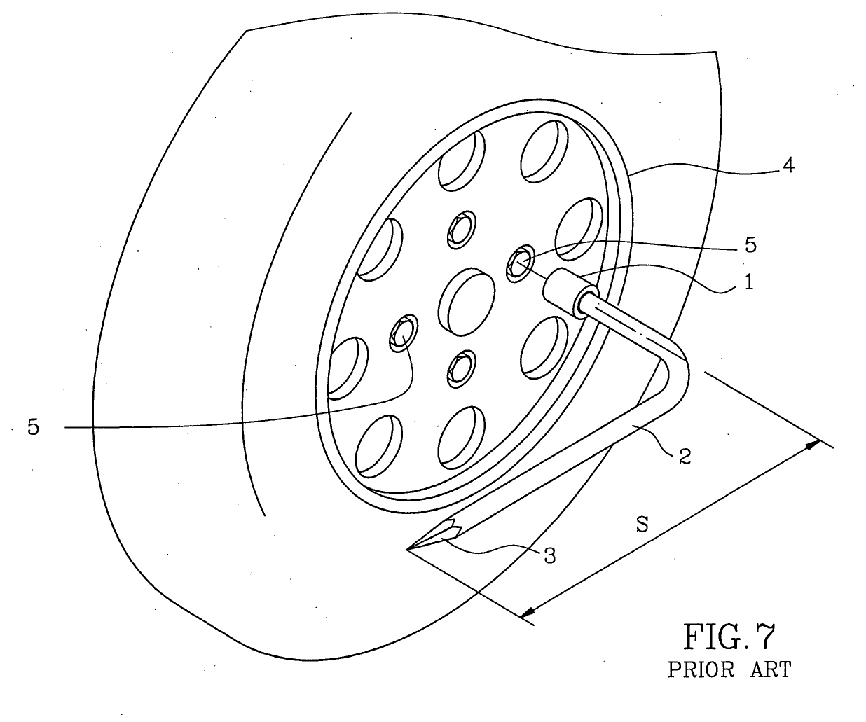

### DETAILED DESCRIPTION OF THE INVENTION

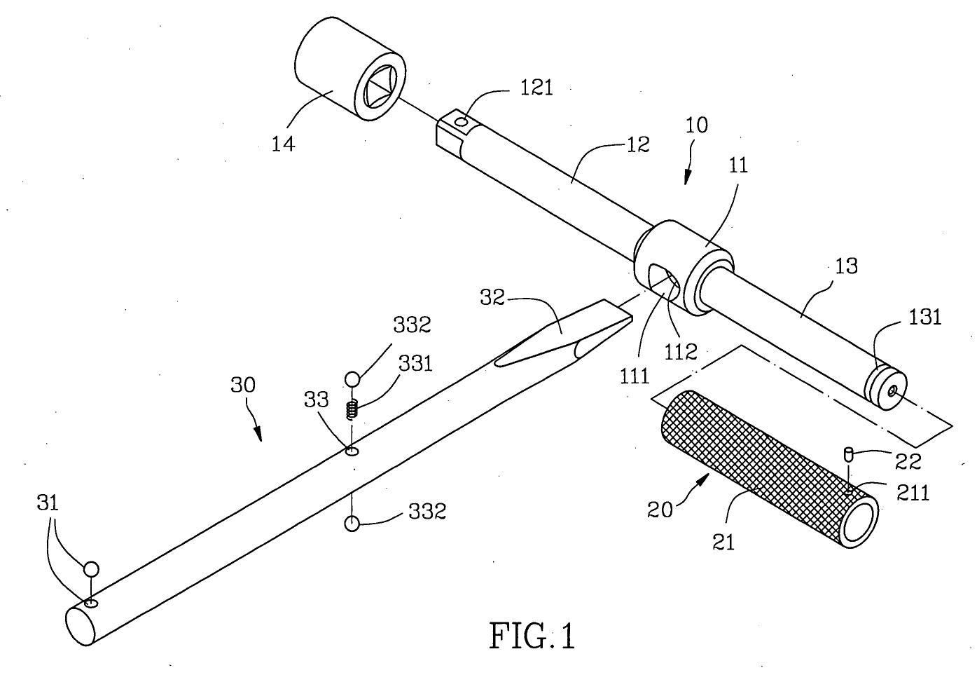

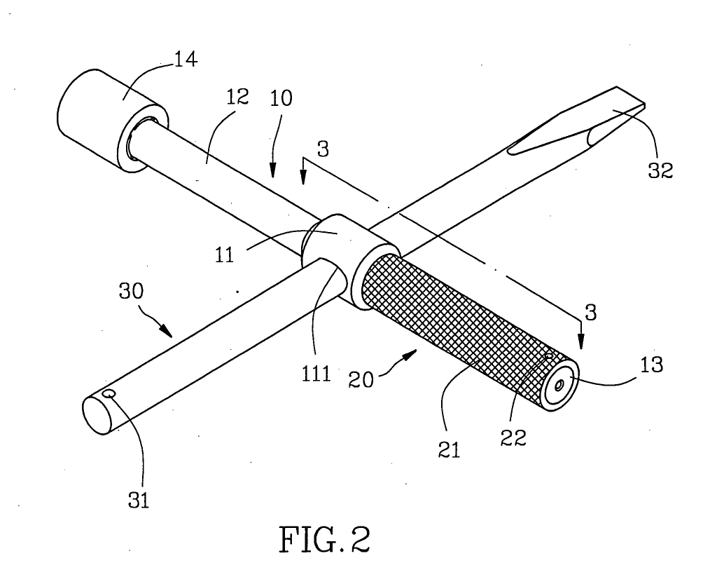

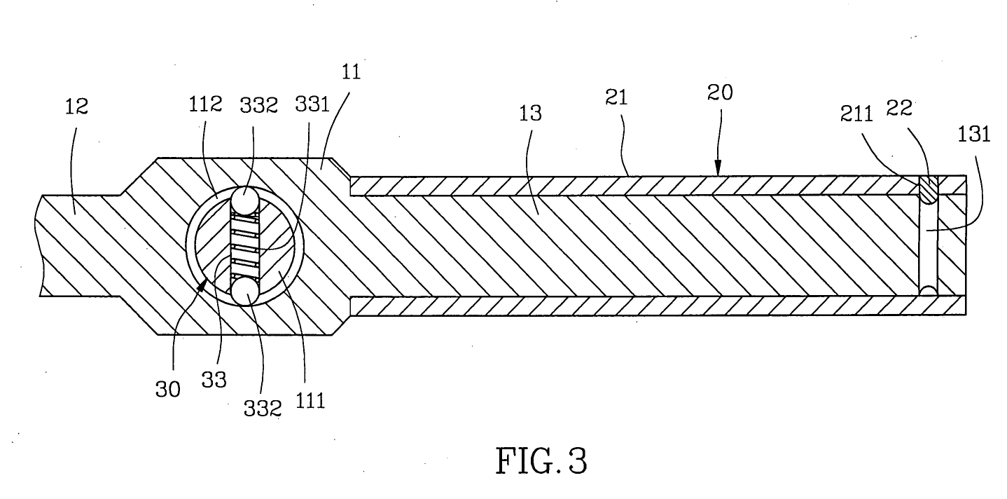

Referring to the drawings and initially to FIGS. 1-3, a hand tool for detaching rim from a vehicle in accordance with the present invention comprises a main shaft (10), a grip (20) rotatably sleeved on one end of the main shaft (10), and drive shaft (30) pivotally and movably extending through a middle portion of the main shaft (10).

The main shaft (10) has a seat (11) formed on the middle portion thereof and dividing the main shaft (10) into a first section (12) and a second section (13). The first section (12) has a cubic head (121) formed on a free end of the first section (12) of the main shaft (10) and the second section (13) has an annular groove (131) defined in a free end of the second section (13) of the main shaft (10). The seat (11) has a hole (111) centrally defined therein and diametrically extending therethrough and a first annular groove (112) defined in an inner periphery of the hole (111). The first section (12) has a cubic head (121) formed on a free end thereof and the second section (13) has a second annular groove (131) defined in a free end of the second section (13) of the main shaft (10). A socket (14) has a first end detachably engaged to the cubic head (131) and a second end adapted to be sleeved on a bolt (5) that is provided to fix the rim (4) on the vehicle.

The grip (20) is rotatably sleeved on the second section (13) of the main shaft (10) and the seat (11) has an outer diameter greater than that of the grip (20) for stopping the grip (20). The grip (20) has a crushed outer periphery (21) for promoting the friction between the grip (20) and the user's palm during operating. A bore (221) is defined in the grip (20) and extends to an inner periphery of the grip (20). The bore (221) communicates with the second annular groove (131) when the grip (20) is sleeved on the second section (13) of the main shaft (10) and abuts against the seat (11). A pin (22) is securely received in the bore (221) and extending into the second annular groove (131) to prevent the grip (20) from being detached from the main shaft (10).

The drive shaft (30) has a first end (32) extending through the main shaft (10) via the hole (111) in the seat (11) and a second end (31) used as a stopper to prevent the drive shaft (30) from overly extending through the main shaft (10) and detaching from the main shaft (10). In the preferred embodiment of the present invention, the second end (31) of the drive shaft (30) partially receives a steel ball (not numbered) that is selectively engaged to the seat (11). The first end (32) of the drive shaft (30) is taperingly flatted such that the drive shaft (30) can be used as a lever for detaching the rim (4) cover and as a screwdriver for driving a screw. A through hole (33) is defined in a middle portion of the drive shaft (30) and diametrically extends through the drive shaft (30). A spring (331) is longitudinally compressively received in the through hole (33) and two steel balls (332) are respectively partially received in two opposite ends of the through hole (33). The spring (331) has two opposite ends respectively abutting the two steel balls (332) to make the two steel balls (332) respectively extend out of the outer periphery of the drive shaft (30). The two steel balls (332) are selectively partially received in the first annular groove (112) to hold the drive shaft (30) in place relative to the main shaft (10) and adjust the extending length of the drive shaft (30) relative to the seat (11).

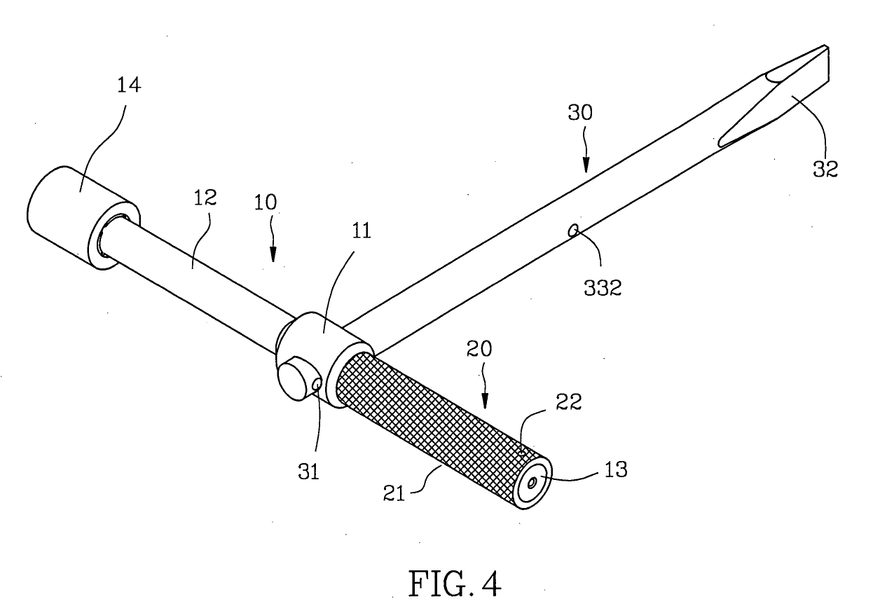

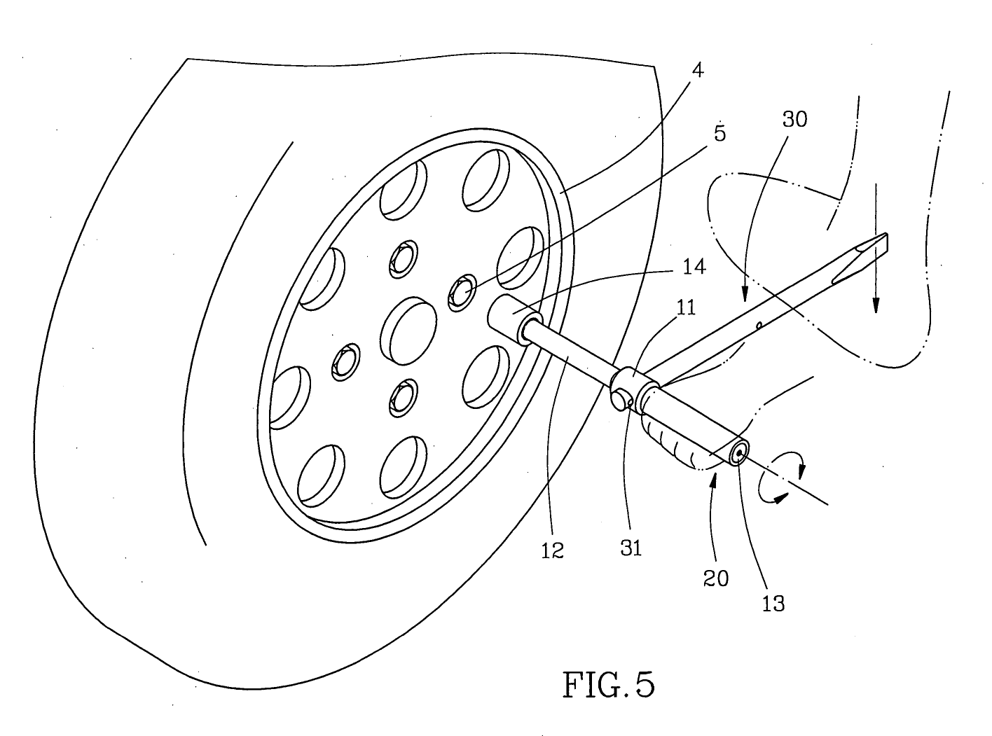

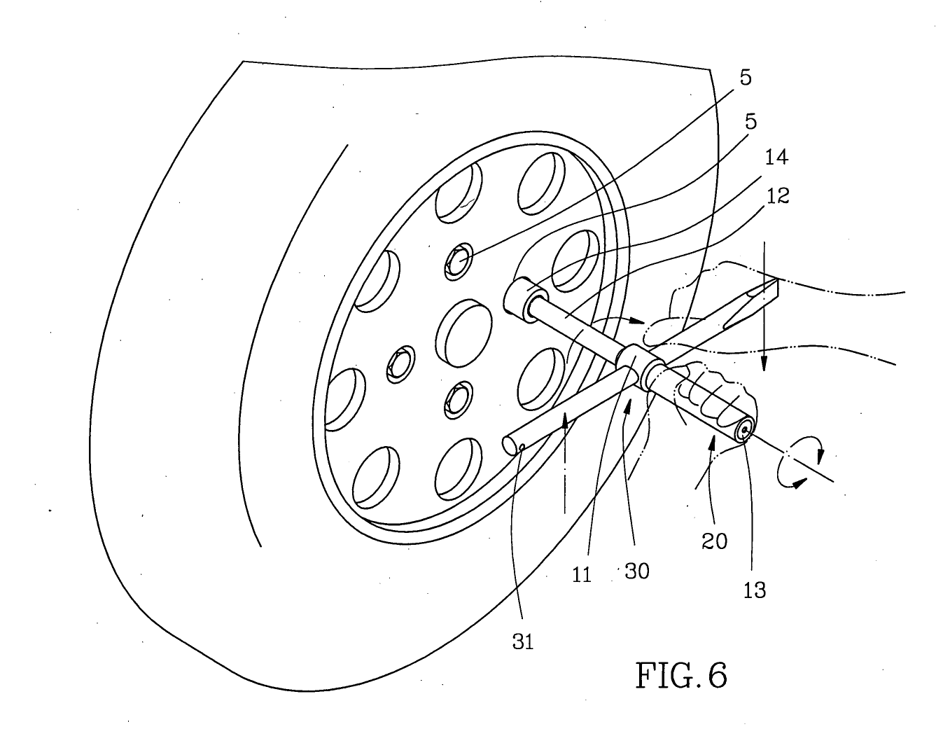

With reference to FIGS. 4-6, when detaching the rim from the vehicle, the drive shaft (30) is firstly used as a lever to detach the rim cover (not shown). Secondarily, the socket (14) is sleeved on the bolt (5) and the drive shaft (30) outermost extends relative to the seat (11) and make the second end (31) of the drive shaft (30) engage to the seat (11) for getting a longest lever arm. Then, the operator can step the first end (32) of the drive shaft (30) when the bolt (5) is tightly mounted. The drive shaft (30) is moved backward relative to the seat (11) to make the two steel balls (332) be partially received in the first annular groove (112). Next, the operator holds the grip (20) and drives the drive shaft (30) to rotate the main shaft (10) for quickly detaching the bolt (5) when the blot (5) is not tight relative to the rim (4). Contrary, for mounting the rim, the sequence of operating steps are reverse to that of detaching rim (4).

As described above, the hand tool in accordance with the present invention comprises the following advantages:

1. The hand tool of the present invention can detach the bolt more quickly than the conventional hand tool because the relative length of the drive shaft (30) is shortened relative to the seat (11) such that the drive shaft (30) would not abut against the ground during operating.

2. The socket (14) and the drive shaft (30) can be detached from the main shaft (10) such that the volume of the present invention is reduced when being stored or carrying. It is a convenient design.

Although the invention has been explained in relation to its preferred embodiment, it is to be understood that many other possible modifications and variations can be made without departing from the spirit and scope of the invention as hereinafter claimed.

What is claimed is:

1. A hand tool for detaching rim from a vehicle, comprising:
a main shaft having a seat formed on a middle portion thereof and dividing the main shaft into a first section and a second section, a hole centrally defined in the seat and diametrically extending through the seat, a socket detachably mounted to a free end of the first section of the main shaft, the socket adapted to be sleeved on a bolt that is used to mount the rim to the vehicle;
a grip rotatably sleeved on the second section of the main shaft for user to control the main shaft, the seat having a diameter greater than that of the grip for stopping the grip; and
a drive shaft pivotally and movably extending through the seat via the hole in the seat, the drive shaft having a taperingly flatted first end such the drive shaft can be used as a lever for detaching a rim cover, the drive shaft having a second end used as a stopper to prevent the drive shaft from overly extending through the seat and detaching from the main shaft during operating.

2. The hand tool as claimed in claim 1, wherein the seat comprises a first annular groove defined in an inner periphery of the hole in the seat, a through hole defined in a middle portion of the drive shaft and diametrically extending through the drive shaft, a spring longitudinally compressively received in the through hole and two steel balls respectively partially received in two opposite ends of the through hole, the spring having two opposite ends respectively abutting the two steel balls to make the two steel balls respectively extend out of the outer periphery of the drive shaft, the two steel balls selectively partially received in the first annular groove to hold the drive shaft in place relative to the main shaft and adjust the extending length of the drive shaft relative to the seat.

3. The hand tool as claimed in claim 1, wherein the stopper of the drive shaft is a steel ball that is partially received in the second end of the drive shaft.

4. The hand tool as claimed in claim 1, wherein the main shaft has a second annular groove defined in a free end of the second section of the main shaft, the grip having a bore defined therein and extending to an inner periphery of the grip, the bore communicating with the second annular groove when the grip is sleeved on the second section of the main shaft and abuts against the seat, a pin securely received in the bore and extending into the second annular groove to prevent the grip from being detached from the main shaft.

5. The hand tool as claimed in claim 4, wherein the grip has a crushed outer periphery for promoting the friction between the grip and the user's palm during operating.
